(19) United States
(12) Patent Application Publication
(10) Pub. No.: US 2024/0375853 A1
(43) Pub. Date: Nov. 14, 2024

(54) CAPSULE WITH A MOISTURE AND OXYGEN BARRIER FUNCTION

(71) Applicant: SOCIETE DES PRODUITS NESTLE S.A., Vevey (CH)

(72) Inventors: CHRISTOPHE SEBASTIEN PAUL HEYDEL, Chez-Le-Bart (CH); ALFRED YOAKIM, St-Legier-La-Chiesaz (CH); CHRISTIAN TALON, Vufflens-le-Chateau (CH)

(21) Appl. No.: 18/691,114

(22) PCT Filed: Sep. 1, 2022
(86) PCT No.: PCT/EP2022/074276

§ 371 Date: Mar. 12, 2024

(30) Foreign Application Priority Data
Sep. 14, 2021 (EP) 21196477.0

(51) Int. Cl. B65D 85/804; B65D 65/46; B65D 81/24

(52) U.S. Cl. CPC B65D 85/8043; B65D 65/466; B65D 81/245; B65D 2565/382

(57) ABSTRACT

The invention relates to a capsule (100) for preparing a beverage in a beverage preparation machine. The capsule (100) comprises a capsule body (110) with a sidewall (111) and a bottom wall (120). The sidewall (111) and the bottom wall (120) delimit a chamber (150) for a substance that is used for the preparation of the beverage. The chamber (150) has an opening (151) opposite to the bottom wall (120) with respect to the chamber (150). The sidewall (111) and/or the bottom wall (120) is/are made from a compostable multilayered sheet material (200), which has a moisture and oxygen barrier function. The sheet material (200) comprises a primary sheet layer (210), which is made of a formable cellulose-based material. The sheet material (200) further comprises one or more secondary layers (220) that comprise at least a moisture barrier layer (221) for the moisture barrier function. The invention also relates to a method for producing said capsule (100).

### 1. FIELD OF THE INVENTION

The present invention relates to a capsule for preparing a beverage in a beverage preparation machine. The invention also relates to a method for producing said capsule.

### 2. TECHNICAL BACKGROUND

Single-serve beverage containers, such as capsules or pods, are known in the art. These beverage containers are commonly used with beverage preparation machines for on demand dispensing of beverages, like coffee, tea or hot chocolate, and enjoy popularity due to fresh tasting, variability of flavours and convenience of the beverage preparation.

Usually, the beverage container encloses a beverage component and is inserted in a container receiver (e.g. a capsule holder) of a beverage preparation machine. The container receiver is closed and the beverage preparation is started. A fluid, such as hot water or milk, is injected in the beverage container to interact with the beverage component inside the beverage container to produce the desired beverage. When a sufficient amount of the fluid fills the beverage container, the beverage container opens under the pressure of the fluid built up in the beverage container to release the prepared beverage. Such beverage preparation is convenient as users can simply decide for a beverage of their liking, place a beverage container of the desired flavour in a machine, start the beverage preparation process and consume the beverage shortly afterwards.

In the prior art, such beverage containers are usually made of plastic and/or aluminium. Considering that such beverage containers are configured for single time use only, the disposal of the beverage containers has to be managed since reusing and recycling such materials is challenging. Therefore, attempts are made to replace these materials with alternative materials that overcome existing problems with disposing and/or recycling.

The problem of disposing the beverage container after its use can be overcome by using cellulose for the beverage container since cellulose is compostable and has a material strength that is sufficient to provide the container with the rigidity required in the beverage preparation process. However, unlike the aforementioned materials used in the prior art, cellulose does not inherently possess an oxygen or moisture barrier. In general, an oxygen and/or moisture barrier is needed to protect the components inside the beverage container from degradation and to retain the components' flavours. Thus, an oxygen and moisture barrier is important for the shelf life of the beverage container. Hence, there is a need for cellulose based beverage containers to have barrier properties.

In general, it is known to provide a cellulose based body with a plastic film, for example by laminating. Unfortunately, most compostable materials, like biopolymers, have only one or the other of the two required barrier properties. For example, if a compostable material has the oxygen barrier properties required for food packaging applications, it typically exhibits relatively low moisture barrier properties, and vice versa. Approaches, where different compostable materials are simply combined to improve barrier performance, proved to be insufficient for food packaging. Also, adhesion between materials with the respective barrier property is difficult to achieve without complex manufacturing processes, which render such material combinations impractical.

Therefore, it is an object of the present invention to provide a compostable beverage container, such as a capsule or pod, having an oxygen barrier and a moisture barrier. Further, it is an object of the invention to provide a method that facilitates production of such beverage containers. Therein, it is a particular object of the invention to improve the production of compostable beverage containers having a prolonged shelf life.

These and other objects, which become apparent upon reading the description, are solved by the subject-matter of the independent claims. The dependent claims refer to preferred embodiments of the invention.

### 3. SUMMARY OF THE INVENTION

A first aspect of the invention relates to a capsule for preparing a beverage in a beverage preparation machine. The capsule comprises a capsule body with a sidewall and a bottom wall. The sidewall and the bottom wall delimit a chamber. The chamber is suitable for containing a substance for the preparation of the beverage. The chamber has an opening opposite to the bottom wall with respect to the chamber. The sidewall, the bottom wall, or the sidewall and the bottom wall is/are made from a compostable multilayered sheet material. The sheet material has a moisture and an oxygen barrier function. The sheet material comprises a primary sheet layer that is made of a formable cellulose-based material. The sheet material further comprises one or more secondary layers comprising at least a moisture barrier layer for the moisture barrier function.

In other words, a capsule as a receptacle for a substance for preparing a beverage in a beverage preparation machine can be provided. For example, the capsule may be a container and/or pod. The capsule comprises a capsule body with a sidewall and a bottom wall that (together) enclose a compartment, (hollow) space and/or cavity. Thus, the capsule may have a three-dimensional body defining the limits and/or contours of the chamber (and/or of the capsule). The three-dimensional body may be configured such that it has a position, where a (first) wall may form the side of the capsule and another (second and/or different) wall may form a lower part of the capsule. The chamber has an opening opposite to the bottom wall with respect to the chamber (and/or the sidewall). Thus, the three-dimensional body may be configured such that, in the aforementioned position, the opening may be on an upper part of the capsule.

The chamber may contain a substance for the preparation of the beverage. The substance may be any type of (solid, liquid, at least partially soluble and/or percolateable) matter of a particular or definite chemical constitution. Injecting a fluid in the chamber during the beverage preparation process may lead to an interaction of the fluid with the substance, which may include any kind of chemical and/or physical reaction between the substance and the fluid, such as wetting, infusion, extraction, dissolution, and/or any other kind of corresponding interaction to produce a beverage product.

The sidewall and/or the bottom wall, is/are made (consist) of a compostable material. Therein, international standards, such as EU 13432 or US ASTM D6400, specify technical requirements and procedures for determining biodegradability and compostability of a material. For example, one of the tests requires that—for a material to be considered “(industrially) compostable”—at least 90% of the material in question must be biologically degraded under controlled conditions in 6 months. Similar test schemes exist also for a certification to home compostability.

The material of the sidewall and/or the bottom wall may have a construction (configuration) that may be formed by layers, plies, slats, tiers or strata. Preferably, the layers may be stacked on top of each other in a direction normal to the respective surface covered by the layers. Furthermore, the sidewall and/or the bottom wall is/are made of a sheet material. Thus, the material may be provided (configured) as a relatively large, thin and flat (with respect to its respective dimensions) and preferably flexible (e.g. it may deform/bend (elastically) under own weight) piece.

The sheet material comprises a moisture barrier function as well as an oxygen barrier function, i.e. it may comprise a configuration that may prevent or block gases, such as oxygen, and also fluids (i.e. liquid and/or vaporous substances) from entering and/or leaving the (cavity) inside of the beverage container, preferably to an extent suitable for food applications. Naturally, the layered structure may also be configured to provide a barrier function against other gases than oxygen, e.g. flavouring substances or Carbon dioxide. The sheet material comprises a first layer that may be (consist) of a formable cellulose-based material. Therein, the term “formable” may be understood, for example, as the characteristic of a material of being malleable, pliable, and/or shapeable, preferably with or without the support of additional tools and/or preferably with or without the application of heat and/or water. The sheet material further comprises additional further layers with at least one layer providing the function of the moisture barrier.

By using a formable compostable sheet material for forming (all) parts of the capsule body, it is possible to provide a capsule from a compostable material that has a moisture barrier and an oxygen barrier since layers providing the respective functionalities can be applied on the sheet material before bringing the same in the shape of the capsule body. Thereby, it is possible to simplify the production process of the capsule significantly since the starting material comprises already the required barrier functionalities and further processing is not needed after forming the capsule. As a result, also adhesion between the respective materials can be improved as the barrier application process can be tailored to the individual needs of the respective materials without having to take into consideration constrains due to the geometry of the three-dimensional capsule body or aspects of food safety. For instance, the adhesion of a plastic material to the cellulose-body and/or another plastic material may improve by applying a uniform pressure. Ensuring such conditions with a three-dimensional body is more challenging than compared to a sheet material. Thus, with the present invention it is possible to overcome the above-described problems of prior art beverage containers.

According to a preferred embodiment, the sheet material may have an oxygen barrier function that provides an oxygen barrier with an oxygen transmission rate (OTR) lower than 5 cc/(m²⋅day). Preferably, the OTR may be in the range of 5⋅10−5 to 5⋅10⁻³ cc/(m²⋅day). Therein, the OTR may be a measure of the amount of oxygen gas that passes through a substance over a defined period. For example, OTR may be measured using known methods specified in industrial standards, such as DIN 53380-3, ASTM D1434 or ISO 2872.

According to a further preferred embodiment, the sheet material may have a moisture barrier function that provides a moisture barrier with a moisture transmission rate (MTR) below 1 g/m²/day. Preferably, the MTR may be in the range of 0.001 to 0.1 g/m²/day. Therein, the MTR may be a measure of the passage of moisture (e.g. water vapour) through the walls of the capsule. For example, the MTR may be measured using known methods specified in industrial standards, such as ASTM E96.

Thereby, the capsule can be provided with high barriers against moisture and oxygen that may be particularly suitable for food packaging. In addition, the sheet material may not only act as a gas and moisture barrier, but also provide printability of the capsule, UV resistance and antibacterial properties.

According to a preferred embodiment, the primary sheet layer may be made of a paper-based material. For example, the primary sheet layer may be Kraft-paper. Therein, Kraft paper may be a paper or cardboard consisting of pulp produced in the “kraft process”. Kraft paper and its consistency is generally known in the art. In the kraft process, wood is converted into wood pulp consisting of almost pure cellulose fibres.

Thereby, it is possible to provide the capsule from a compostable material that has a high tensile strength, for example 100 MPa, in comparison to other paper sheets.

Preferably, the primary sheet layer may have a grammage between 100 g/m² to 400 g/m², more preferred between 100 g/m² to 224 g/m², and even more preferred between 100 g/m² to 130 g/m². Alternatively or additionally, the primary sheet layer may be configured such that it has an elongation at its breaking point of at least 2%, preferably between 2% and 20%, more preferred between 5% and 10%. Alternatively or additionally, the sidewall and/or the bottom wall may have a shape that (e.g. depending on the formability of the primary sheet layer material) allows to keep the (maximum) amount of strain beyond 5%, more preferred in a range between 1% to 5%.

This configuration of the primary sheet layer allows to reduce the strain (e.g. the displacement between particles in the material relative to a reference length) occurring during the transformation process of the sheet material into the sidewall and/or bottom wall (e.g. forming, bending, or shaping). Accordingly, the respective parts of the capsule body are not stretched beyond a certain degree, such as the stretch ratio or engineering strain. Preferably, the amount of (engineering) strain may be beyond 5%, more preferred in a range between 1% to 5%. Thereby, the integrity of the moisture and oxygen barrier function can be ensured since the layers of the (former) sheet material providing the moisture and/or oxygen barrier function are not exposed to (undue) shearing forces or plastic deformation. Thus, the production of the capsule can be improved while ensuring the integrity of the moisture and oxygen barrier of the sheet material.

According to a further preferred embodiment, the moisture barrier layer may be applied directly (i.e. in immediate physical contact) on the primary sheet layer. For example, the moisture barrier layer may comprise Polyvinylidene dichloride (PVDC), nanocellulose, microcellulose, Silicon nitride, Silicon oxide, Aluminium, and/or Aluminium oxide. The moisture barrier layer may be provided as a coating or a film, e.g. by laminating, spraying, lacquering, plasma coating or metallisation (e.g. physical vapour depositing).

Thereby, the capsule can be provided with a moisture barrier layer, which is effected by high barrier materials, without losing the compostability of the capsule. Furthermore, good adhesion between cellulose and other plastic layers may be achieved with the respective processes used for providing the moisture barrier layer.

According to a preferred embodiment, the primary sheet layer may comprise the oxygen barrier function. Therein, the oxygen barrier function may be provided by the cellulose-based material of the primary sheet layer. For example, the cellulose-based material may have a composition or compactness that may provide the oxygen barrier function. Alternatively or additionally, the cellulose-based material may be treated in a chemical process to provide the oxygen barrier function. For example, the cellulose-based material may be treated with acids. Alternatively or additionally, the cellulose-based material may be treated in a mechanical process. For example, the cellulose-based material may be treated in a calendering process.

Thus, the oxygen barrier function can be provided by the primary sheet layer by adapting a region on and below its surface. In addition, the modification of the surface structure of the primary sheet layer may lead to improving the bond (adhesion) between the primary sheet layer and other dissimilar materials (e.g. materials of secondary layers). For example, in a calendering process, the cellulose material may be exposed to heat and pressure so that the surface texture changes. Similar modifications of the surface texture may be derived by chemically treating the surface of the primary sheet layer. The change in the surface texture may be observed directly on the surface and/or up to a certain depth below the surface that was treated in the respective process. For example, pore size, air permeability and/or surface roughness may be changed in such processes.

According to a preferred embodiment, the secondary layers may comprise an oxygen barrier layer for providing the oxygen barrier function. The oxygen barrier layer may be provided on an opposite side to the primary sheet layer with respect to the moisture barrier layer. Preferably, the moisture barrier layer may be sandwiched between the oxygen barrier layer and the primary sheet layer. The oxygen barrier layer may be made of Polyvinyl Alcohol (PVOH) or Butenediol Vinyl Alcohol Co-polymer (BVOH). The oxygen barrier layer may be a coating or film. The oxygen barrier layer may be provided in a laminating, spraying, lacquering, plasma coating or metallisation process.

Thereby, the capsule can be provided with an oxygen barrier layer, which is effected by high barrier materials, without losing the compostability of the capsule. Furthermore, good adhesion between cellulose and other plastic layers may be achieved with the respective processes used for providing the moisture barrier layer.

According to a preferred embodiment, the secondary layers may comprise at least one masking layer. The masking layer may be a sealant for heat sealing. Preferably, the masking layer may be suitable (and/or configured) for masking the oxygen barrier layer. Preferably, the oxygen barrier layer may be sandwiched between two masking layers. For example, the masking layer may be made of a (compostable) plastic material. Polyhydroxyalkanoic acid (PHA), Polybutylene Adipate Terephthalate (PBAT) or Polylactic acid (PLA) may be used, for instance, to form the masking layer.

Thereby, a layer for covering or obscuring other layers can be provided, for example to protect the integrity of layers forming the respective barriers from scratches or other environmental influences (temperature, exposure to gases or UV degradation). This may be particularly relevant in case the respective layers are formed as relatively thin coating layers, such as derived in metallization processes, and thus, more susceptible to being mechanically damaged.

According to a further preferred embodiment, the primary sheet layer or the secondary layers may comprise at least one base layer. For example, the moisture barrier layer may be sandwiched between two base layers. The base layer may be configured to provide a reduced pore size, air permeability and/or surface roughness in comparison to another layer of the sheet material, on which the base layer is applied. Preferably, the base layer may be applied directly onto the moisture barrier layer. Alternatively or additionally, the base layer may be applied directly onto the masking layer (if present). Preferably, the base layer may be provided by the cellulose-based material of the primary sheet layer.

For example, the base layer may be provided by treating the cellulose-based material in a chemical (under the application of acids) or in a mechanical (calendering) process. Alternatively or additionally, the base layer may be provided as a (compostable) plastic material or film. For example, the material or film may comprise Polybutylene Adipate Terephthalate (PBAT), Polylactic acid (PLA) or regenerated cellulose.

Thereby, the adhesion between the primary sheet layer and following secondary layers (or between secondary layers) can be improved. For example, unevenness, voids or pores of the respective surface covered by the base layer can be filled evenly. Thereby, uniform interlocking between layers can be improved.

According to a further preferred embodiment, the outside surface of the capsule body, the chamber or both may be delimited by the primary sheet layer.

Thereby, it is possible to shield the secondary layers from environmental influences through the primary sheet layer. Also, it can be ensured that the cellulose body does not absorb any of the fluid injected into the chamber. Further, printing on the capsule can be improved.

Alternatively or additionally, the outside surface of the capsule body, the chamber or both may be delimited by the secondary layers. Preferably, if present, the masking layer may delimit the outside surface of the capsule body, the chamber or both of the aforementioned structures.

By providing the secondary layers on the outside of the capsule, it can be avoided that the beverage container gets stuck or dissolves inside the container receiver of a beverage preparation machine.

According to a preferred embodiment, the bottom wall may be separate from the sidewall.

Thereby, the mechanical strain on the sheet material can be reduced further as the bottom wall and the sidewall of the capsule body are provided as two detached (unconnected/different/distinct) parts. Accordingly, the integrity of the moisture and oxygen barrier provided on the respective walls can be ensured. In addition, it is possible to simplify and accelerate the production process of the capsule.

According to a further preferred embodiment, the capsule body may comprise a rim portion at the opening. Preferably, the rim portion may protrude laterally away from the opening. The rim portion may be integrally provided with the sidewall.

Thus, a membrane or lid can be provided on the capsule to seal and close the chamber.

According to a preferred embodiment, the sidewall may comprise an attachment portion for attaching the bottom wall to the sidewall. For example, the sidewall may be attached to the bottom wall at the attachment portion by heat-sealing or folding. The attachment portion may be provided on a longitudinal end section of the sidewall, which is opposite to the opening with respect to the chamber.

Thereby, a reliable and sealing connection between the two separate components may be provided so the integrity of a substance contained inside the chamber can be ensured.

According to a preferred embodiment, the bottom wall may be flush with an end section of the sidewall that is opposite to the opening with respect to the chamber. Thus, a surface of the bottom wall facing away from the chamber may form a single surface with a surface of the end section of the sidewall, which faces in the same direction as the bottom wall, may be at the same height or distance from the opening. Thereby, it is possible to rest the capsule on the bottom wall.

Alternatively, an end section of the sidewall (that is opposite to the opening with respect to the chamber) may project from the bottom wall in a (angled) direction opposite to the opening (and in a direction towards or away from the capsule interior).

Thereby, the capsule may be provided at its lower end with a skirt portion, on which the capsule may be rested for storage without the bottom wall coming into contact with the underground. Thus, the hygienic conditions of the beverage preparation can be improved with the so configured capsule.

According to a further preferred embodiment, the sidewall may be formed by securing opposite end sections of the sheet material to each other. For this, the opposite end sections of the sheet material may preferably be overlapped and a separate strip may be attached to one of the end sections and (the strip may be) folded over the front face of the one end section. Alternatively, the end sections of the sheet material may be secured to each other by abutting the end sections on their respective front faces and a separate strip being attached on each of the end sections on the same side with respect to the chamber so as to extend the strip over the abutting front faces.

Thereby, it can be ensured that the sidewall provides a reliable oxygen and moisture barrier at a joining section where two portions of the sheet material may be joined. Often, the thickness of the material increases with joining two sections, which can lead to gaps and hollow spaces enclosed by the sections forming an entrance in the chamber. Thus, with the above described configurations, the integrity of a substance contained inside the chamber can be ensured as a separate element with barrier properties is provided to close such gaps or hollow spaces.

A further aspect of the present invention relates to a method for producing the capsule described in detail above. The method comprises the step of providing the compostable multilayered sheet material with a moisture and oxygen barrier function. The sheet material is formed as to form the sidewall and/or the bottom wall of the capsule body. For example, the sidewall may be formed with a separate strip as described above. The bottom wall is attached (e.g. connected/joined/adhered/sealed) to the sidewall so that the bottom wall and the sidewall form the capsule body that encloses the chamber. The chamber is filled with a substance for the preparation of the beverage through the opening. The opening is sealed with a membrane to close the chamber. Thus, the chamber may be covered by the lid, the bottom wall, and/or the sidewall such that substances, such as gas, liquid or solids, may be prevented from passing into or out of the chamber. Preferably, in the step of forming the sheet material, the sheet material may be bent such that the secondary layers form the outside of the capsule body or face inside the chamber. Preferably, the sidewall and the bottom wall may have a different or the same orientation of the primary sheet layer and the secondary layers with respect to the chamber.

Thereby, it is possible to produce a compostable capsule with a moisture and an oxygen barrier that possesses all advantages described above for the capsule. In particular, it is possible to simplify the manufacturing process of a compostable capsule while facilitating the provision of a reliable oxygen and moisture barrier on the capsule. Therein, using a sheet material is particularly advantageous as the container may be formed and filmed as part of the same process and no further process steps concerning the production of the capsule are required (e.g. no additional coating steps are needed).

A further aspect of the present invention relates to a use of the capsule described above for preparing a beverage in a beverage preparation machine.

Further features, advantages and objects of the invention will become apparent for the skilled person when reading the following detailed description of embodiments of the invention and when taking in conjunction with the figures of the enclosed drawings. In case numerals have been omitted from a figure, for example for reasons of clarity, the corresponding features may still be present in the figure.

### 4. BRIEF DESCRIPTION OF DRAWINGS

FIG. 1 shows a schematic cross-section of a section of a capsule according to an embodiment of the invention.

FIG. 2 shows a cross-section of a capsule according to a further embodiment of the invention.

FIG. 3 shows a perspective view of the capsule of FIG. 2.

FIG. 4 shows a cross-section of a capsule according to a further embodiment of the invention.

FIG. 5 shows a perspective view of a capsule according to a further embodiment of the invention.

FIG. 6 shows a perspective sectional view of a capsule according to a further embodiment of the invention.

FIG. 7 shows a cross-section of the capsule of FIG. 6.

FIG. 8 shows a perspective sectional view of a capsule according to a further embodiment of the invention.

FIG. 9 shows a cross-section of the capsule of FIG. 8.

FIG. 10 shows a perspective view of a bottom wall of a capsule according to a further embodiment of the invention.

FIG. 11 shows an exploded detail view of a capsule at the opening according to a further embodiment of the invention.

FIG. 12 illustrates problems existing with sealing capsules of the prior art.

FIG. 13 shows a detail view of a sealed capsule according to a further embodiment of the invention.

FIG. 14A shows a sectional view through the sidewall of a capsule according to a further embodiment of the invention.

FIG. 14B shows a detail view of a section of the capsule of FIG. 14A.

FIG. 15A shows a sectional view through the sidewall of a capsule according to a further embodiment of the invention.

FIG. 15B shows a detail view of a section of the capsule of FIG. 15A.

FIG. 15C shows a detail view of a section of a modified capsule of FIG. 15A.

### 5. DETAILED DESCRIPTION

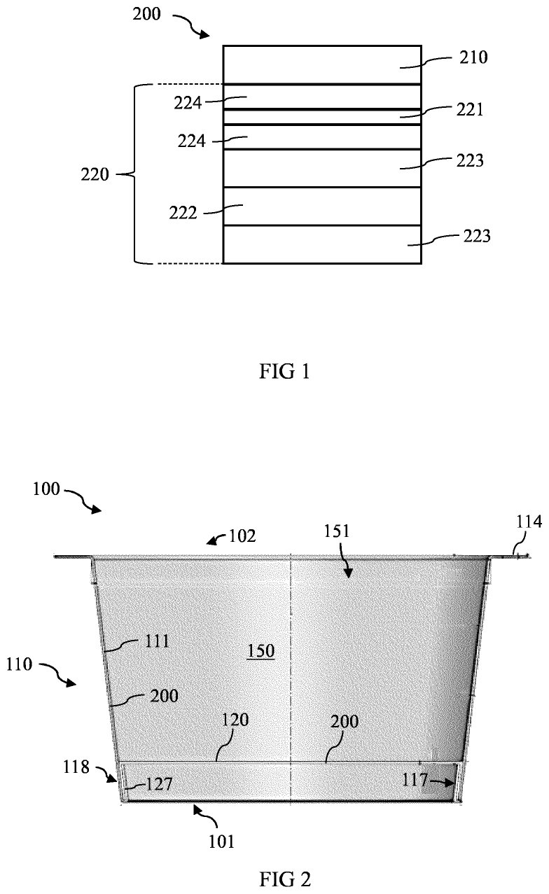

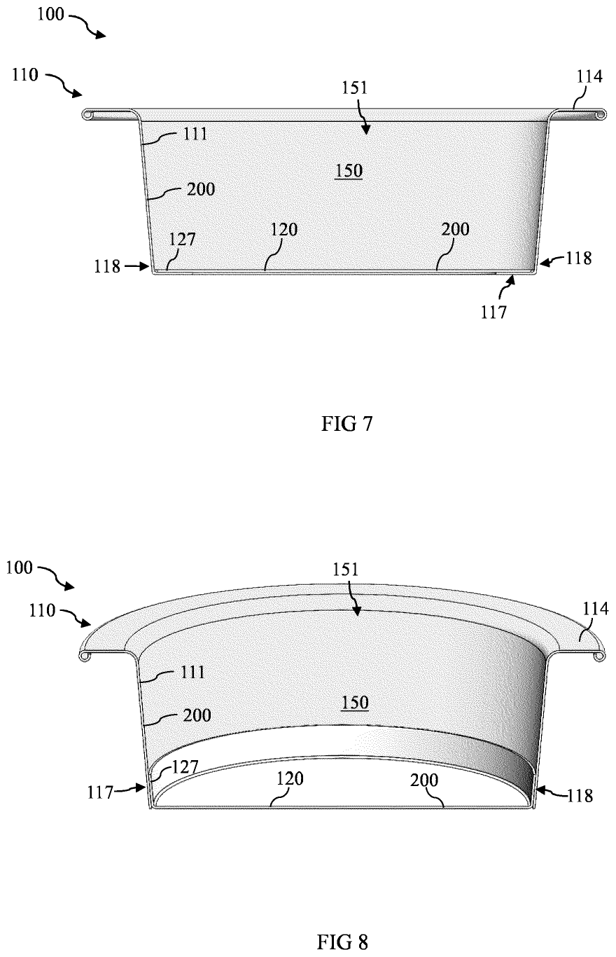

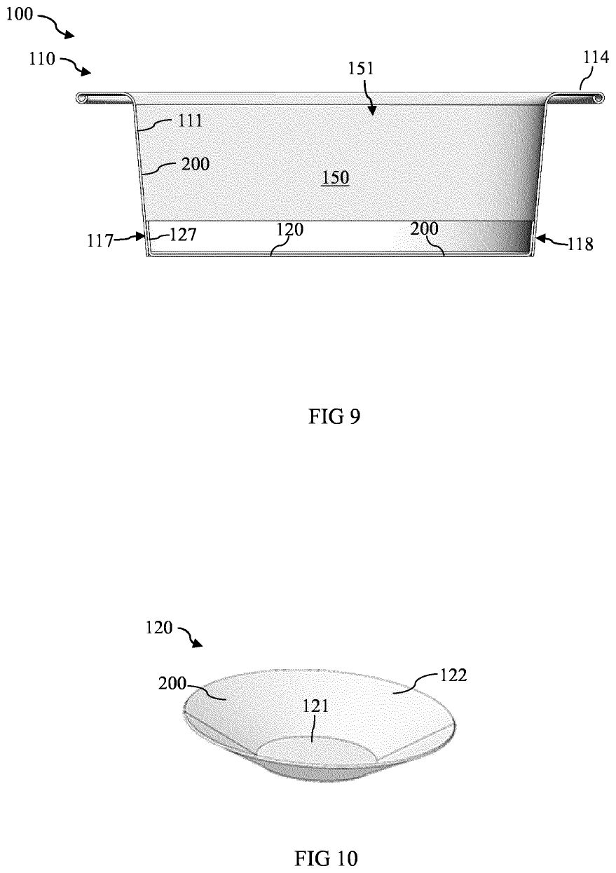

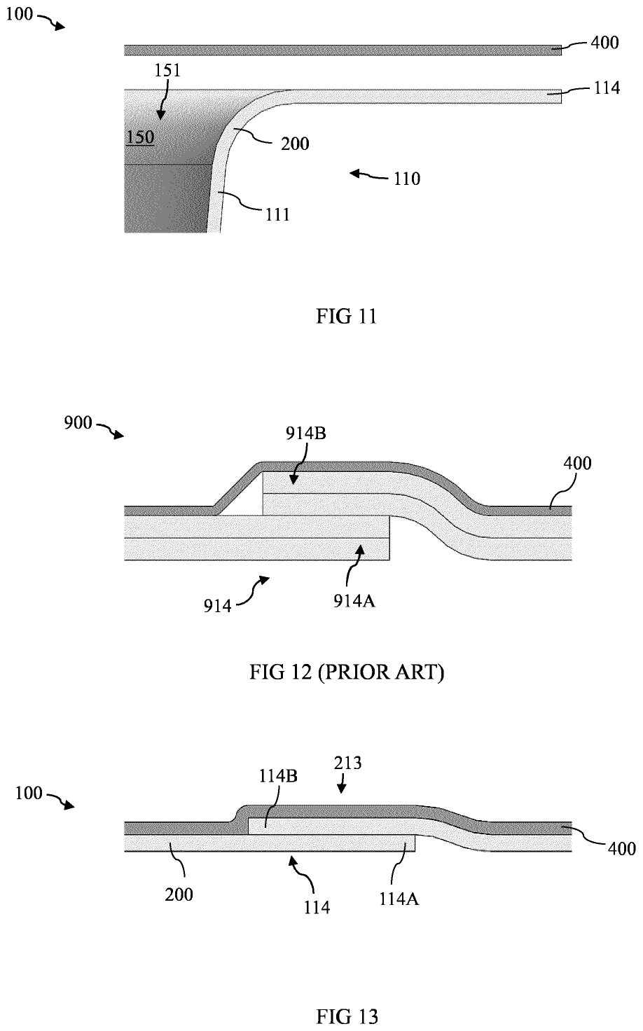

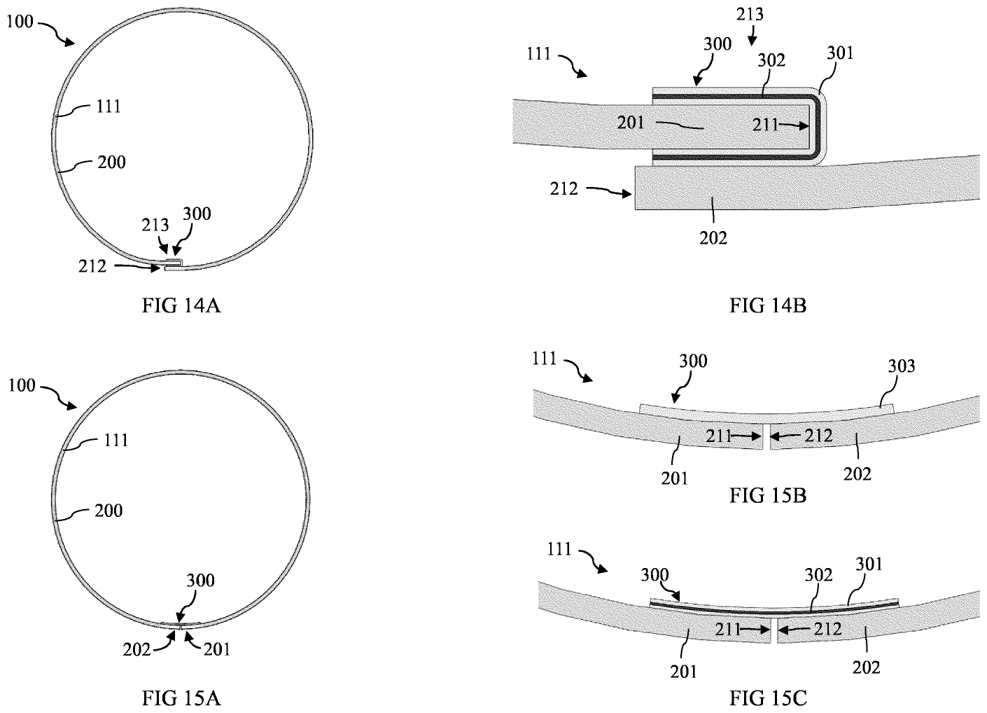

All Figures—except for FIG. 12—show different views and aspects of different embodiments of a capsule 100 according to the invention. FIG. 1 shows a schematic illustration of a cross-section of a section of the capsule 100 of the invention. FIGS. 2 to 10 show different views of different embodiments of the capsule 100 of the invention. FIGS. 11 and 13 show aspects of sealing an embodiment of the capsule 100 closed. FIG. 12 visualises existing problems with beverage containers of the prior art. FIGS. 14 and 15 show aspects of forming the capsule 100 of the invention in different ways.

The capsule 100 is suitable for preparing a beverage in a beverage preparation machine. For example, the capsule 100 may be placed inside a capsule holder of a beverage preparation machine. The beverage preparation machine may be a capsule machine, for example. A fluid may be injected inside the capsule 100 for preparing a beverage. The fluid may be hot (40° C. to 100° C.) water or milk and may be injected under pressure (1 to 10 bar). For this, the beverage preparation machine may have piercing elements to access the capsule 100 for injecting the fluid. The capsule 100 may have any shape or form that may be suitable for preparing a beverage with a machine like the beverage preparation machine. For example, the capsule 100 may have a round (circular) base and/or may have the shape of a cylinder or a conical frustum. This is exemplarily shown in FIGS. 2 to 10. The capsule 100 may extend longitudinally between two opposite ends, namely a first end 101 for fluid to enter the capsule 100, and a second end 102 for the prepared beverage to exit the capsule 100. This is exemplarily shown in FIGS. 2 and 5, but may be applicable to other Figures also. Preferably, the capsule 100 may be made of material(s) and/or contain substances that are (all) compostable. Preferably, the capsule 100 may have the required stiffness (e.g. combination of capsule material and capsule design leading to a defined resistance to deformation under external forces) for producing a beverage under pressure in a beverage preparation machine.

The capsule 100 comprises a capsule body 110. For example, the capsule body 110 may be a three-dimensional body. This is exemplarily shown in FIGS. 2 to 11. Preferably, the capsule body 110 may be configured (with regards to material and structural design) such that, for example, if produced from a blank, 50% or more, preferably at least 90% of its surface facing inside the capsule 100 may be stretched at most by 10%, preferably at most by 1% to 5%, during the forming process of the capsule body 110.

The capsule body 110 comprises a sidewall 111. Preferably, the sidewall 111 may have a closed profile and may form a continuous surface. This is exemplarily shown in FIGS. 2 to 11 as well as 14 and 15.

The sidewall 111 is made from a compostable multilayered sheet material 200. FIG. 1 shows an exemplary cross-section through the different layers of the sheet material 200. However, although not explicitly described in the following, it is also conceivable that the sidewall 111 is made of a different compostable material than the sheet material 200 (as long as at least one wall portion of the capsule body 110 is made of the sheet material 200). The sheet material 200 may be a sheet or blank with a substantially rectangular form. However, this is not a complete enumeration and other shapes are conceivable, such as a ring shape.

The sheet material 200 comprises a primary sheet layer 210 that is made of a cellulose-based material. For example, the primary sheet layer 210 may be made of a paper-based material, such as Kraft-paper. Thus, the primary sheet layer 210 may comprise biodegradable pulp material, like pulp fibre cellulose, bagasse pulp, bamboo pulp, and/or wood pulp. Accordingly, depending on the pulp fibre used, the stiffness of the primary sheet layer 210 may vary. For example, the primary sheet layer 210 may have a grammage between 100 g/m² to 400 g/m².

The material of the primary sheet layer 210 is also formable. Therein, for example, the primary sheet layer 210 may be configured to have an elongation at its breaking point of at least 2%, preferably between 2% and 20%, more preferred between 5% and 10%. Thus, the sidewall 111 may be made by forming and/or pulp moulding. Therein, the pulp may be pressed (with or without applying heat) into a mould to form the sidewall 111. However, these are only examples and other forming methods are conceivable.

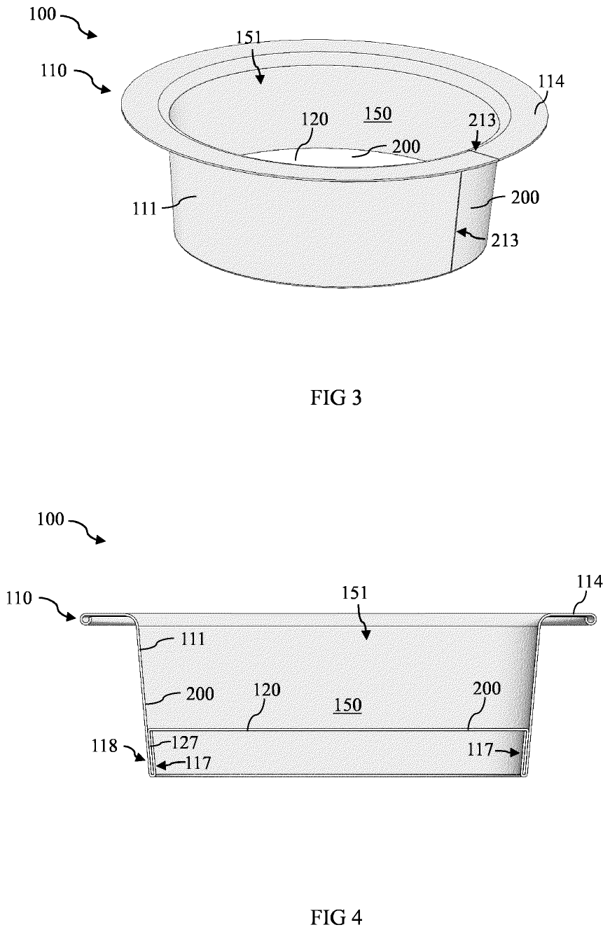

The primary sheet layer 210 being formable may be used for providing the sidewall 111. FIGS. 14 and 15 illustrate exemplarily how the sidewall 111 may be made from the sheet material 200. The sheet material 200 may be bent, folded or shaped. Therein, it is conceivable that two opposing free end sections 201, 202 of the sheet material 200 may be positioned in immediate proximity to each other to form the sidewall 111. This is exemplarily illustrated in FIGS. 14 and 15. For example, in FIG. 14A, the two end sections 201, 202 may be arranged to overlap with each other. The two end sections 201, 202 may be secured to each other by bonding the two end sections 201, 202 within an area 213, in which the two end sections 201, 202 overlap. This is exemplarily illustrated in FIGS. 3, 13 and 14. For this, for example, heat sealing or an adhesive may be used. Alternatively or additionally, a separate strip 300 may be attached to one of the end sections 201, 202 and folded over the respective front face 211, 212 of the one of the end sections 211, 212. In FIGS. 14A and 14B, this is exemplarily shown for the end section 201, which is radially closer to the inside of the capsule 100. However, this is only an example and the strip 300 may be attached on the other end section 202 also. In FIG. 15, the two end sections 201, 202 are exemplarily shown as abutting on their respective front faces 211, 212. The sidewall 111 may be formed by securing the end sections 201, 202 to each other by attaching the strip 300 on each of the end sections 201, 202 on the same side so that the strip 300 extends over the abutting front faces 211, 212.

However, also other ways of making the sidewall 111 from the sheet material 200 exist, which may depend on the shape of the sheet material 200. For example, the sidewall 111 may be formable from a sheet material 200 having a ring-shape to avoid having to adhere free ends of the sheet material 200 to each other.

Preferably, the capsule body 110 or the sidewall 111 may comprise a rim portion 114. The rim portion 114 may be integrally provided with the sidewall 111. This is exemplarily shown in FIGS. 2 to 13. Different designs of the rim portion 114 are conceivable. For example, a radial end portion of the rim portion 114 may be curled inwards with respect to the sidewall 111 (FIGS. 4, 6 to 9). Alternatively, the radial end portion of the rim portion 114 may be flat (FIGS. 2, 3, 5 and 11).

Further, the sheet material 200 comprises a moisture and oxygen barrier function. Thus, the sheet material 200 may be configured such that it reduces moisture and oxygen passing through the sidewall 111 to a certain extent. For example, the sheet material 200 may provide an oxygen barrier with an OTR lower than 5 cc/(m²⋅day) and a moisture barrier with a MTR below 1 g/m²/day. The layered structure of the sheet material 200 may provide the oxygen and moisture barrier function through its individual layers. Preferably, the individual layers of the sheet material 200 may be stacked in a direction normal to the surface covered by the layers, such as the primary sheet layer 210. Preferably, the individual layers of the sheet material 200 may extend continuously in a plane and/or may extend uniformly alongside each other. This is shown in FIG. 1, for example.

The sheet material 200 comprises at least one secondary layer 220. FIG. 1 shows a plurality of secondary layers 220. In the following, it is generally referred to “secondary layers 220”, but the description is equally applicable to a single secondary layer 220.

The secondary layers 220 comprise at least a moisture barrier layer 221 to provide the moisture barrier function. This is exemplarily shown in FIG. 1. The moisture barrier layer 221 may be provided as a coating or a film. For example, the moisture barrier layer 221 may comprise PVDC, nanocellulose, microcellulose, Silicon nitride, Silicon oxide, Aluminium, and/or Aluminium oxide. These may be applied as the moisture barrier layer 221 by laminating, spraying, lacquering, plasma coating, or by metallisation. For example, a physical vapour depositing process may be used. Preferably, the moisture barrier layer 221 may be applied directly on the primary sheet layer 210 (not shown).

The secondary layers 220 may comprise additional layers described in the following:

For example, the secondary layers 220 may comprise at least one base layer 224. This is exemplarily shown in FIG. 1. In the example of FIG. 1, two base layers 224 are provided for being applied directly onto the moisture barrier layer 221 and the primary sheet layer 210. Thus, the moisture barrier layer 221 may be sandwiched between two base layers 224. The base layer 224 may preferably provide a surface as a base, on which various other layers, e.g. films and/or coatings, may be adhered. For this, for example, the base layer 224 may be configured to provide a reduced pore size, air permeability and/or surface roughness in comparison to another layer of the sheet material 200, on which the base layer 224 is applied. For example, the base layer 224 may have a smaller pore size or lower surface roughness than the primary sheet layer 210. Alternatively or additionally, the base layer 224 may form a surface with a surface roughness comprised in the range of from 30 to 800 Bendsten ml/min (Bendsten method). The base layer 224 may be provided as a film or coating. For example, the base layer 224 may be a (compostable) plastic material, like PBAT, PLA or regenerated cellulose.

Alternatively or additionally, it is also conceivable that the primary sheet layer 210 may comprise the (one) base layer 224 (or one of the base layers 224). Therein, the base layer 224 may be provided by the cellulose-based material of the primary sheet layer 210. For example, the primary sheet layer 210 may be mechanically or chemically treated to provide the functionality of the base layer 224. For this, a surface of the primary sheet layer 210 may be treated with acids, and/or may be exposed to pressure and heat in a calendering process.

The oxygen barrier function may be provided by the secondary layers 220, which may further comprise an oxygen barrier layer 222 to provide this function. In the example illustrated in FIG. 1, the oxygen barrier layer 222 is shown as being provided on an opposite side to the primary sheet layer 210 with respect to the moisture barrier layer 221. However, other arrangements of the oxygen barrier layer 222 are conceivable. The oxygen barrier layer 222 may be provided as a coating or a film. For example, the oxygen barrier layer 222 may be made of PVOH or BVOH. Therein, the oxygen barrier layer 222 may be provided as one of the secondary layers 220 by laminating, spraying, lacquering, plasma coating or in a metallisation process.

Alternatively or additionally, the oxygen barrier function may be provided by the primary sheet layer 210. Therein, for example, the oxygen barrier function may be provided by the cellulose-based material of the primary sheet layer 210 itself. For example, the primary sheet layer 210 may have a constitution or composition that allows to provide the above specified oxygen barrier functionality. For instance, the primary sheet layer 210 may comprise a high portion of fibres and/or may have a high compactness. Alternatively or additionally, the primary sheet layer 210 may be mechanically or chemically treated to establish the oxygen barrier function. For this, a surface of the primary sheet layer 210 may be treated with acids, and/or may be exposed to pressure and heat in a calendering process.

The secondary layers 220 may further comprise at least one masking layer 223 for masking the oxygen barrier layer 222. In FIG. 1, the oxygen barrier layer 222 is exemplarily illustrated as being sandwiched between two masking layers 223. FIG. 1 illustrates further that the masking layer 223 may be applied directly onto the base layer 224. The masking layer 223 may be provided as a film or coating. For example, the masking layer 223 may be a (compostable) plastic material, like PHA, PBAT or PLA.

Preferably, the aforementioned strip 300 may comprise a moisture barrier function and an oxygen barrier function. For example, the strip 300 may have a layered structure that comprises a moisture barrier layer and an oxygen barrier layer. This is exemplarily illustrated in FIGS. 14 and 15. For example, the strip may comprise a calendered paper layer 302 (e.g. for providing an oxygen barrier) that may be sandwiched between two layers 301 made of compostable plastic (e.g. for providing a moisture barrier). However, it is also conceivable that the strip 300 is provided as a single-layer film 303 that merely provides additional sealant material.

The capsule body 110 further comprises a bottom wall 120. This is shown, for example, in FIGS. 2 to 11. In particular, FIG. 10 shows an example for a design of the bottom wall 120. The bottom wall 120 may be made of the above described multilayered sheet material 200. Thus, FIG. 1 may show a cross-section exemplary for the sidewall 111 and/or the bottom wall 120. However, it is also conceivable that the bottom wall 120 is made of a different compostable material, like paper (for example, if the sidewall 111 is already made of the sheet material 200). The bottom wall 120 may have any shape or form. For example, the bottom wall 120 may have a circular, plate-like form.

The sidewall 111 and the bottom wall 120 together delimit a chamber 150 for containing a substance for the preparation of the beverage. Thus, the sidewall 111 and the bottom wall 120 may define the shape and contours of the chamber 150. Similarly, the sidewall 111 and the bottom wall 120 may determine the shape and contours of the capsule 100. This is exemplary shown in FIGS. 2 to 11.

The chamber 150 has an opening 151 that is opposite to the bottom wall 120 with respect to the chamber 150. For example, the sidewall 111 may define (surround) an opening 151 of the capsule body 110 and preferably the rim portion 114 may protrude laterally away from the opening 151. The chamber 150 may enclose a substance for beverage preparation. For example, when injecting a fluid inside the capsule 100 for the beverage preparation, the substance may interact with the fluid injected in the chamber 150 to produce the desired beverage. Thus, in the beverage preparation process, the chamber 150 (or more generally the capsule 100) may constitute a brewing chamber of the beverage preparation machine. Examples for substances may be roasted ground coffee, instant coffee, tealeaves, syrup concentrate, fruit extract concentrate, chocolate, dehydrated edible substances, and/or combinations thereof.

Preferably, the chamber 150 may be delimited by the primary sheet layer 210 or the secondary layers 220. For example, if the masking layer 223 is present, the chamber 150 may be covered by the masking layer 223 and thus, form the surface coming into contact with the substance. Alternatively or additionally, the outside surface of the capsule body 110 may be delimited by the primary sheet layer 210 or the secondary layers 220 (and the masking layer 223 in particular, if present). However, these are only examples and not a complete enumeration. In particular, any of the layers of the sheet material 200 may form the most outer or most inner surface of the capsule 100.

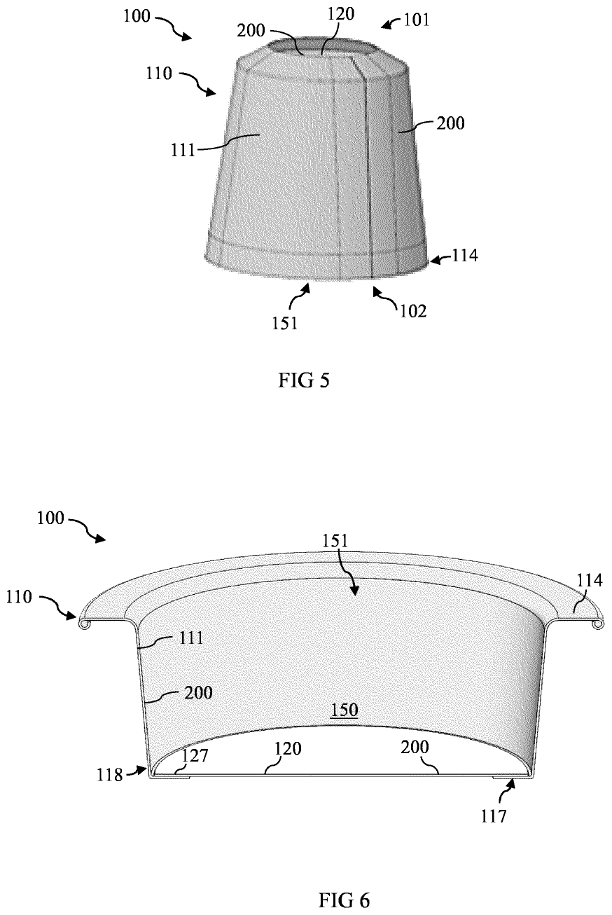

Preferably, the bottom wall 120 may be a separate element from the sidewall 111. This is exemplarily illustrated in FIGS. 2 to 10. The bottom wall 120 may be joined to the sidewall 111 by heat sealing or gluing. For this, the sidewall 111 may comprise an attachment portion 117 for attaching the bottom wall 120 to the sidewall 111. For instance, in FIGS. 2 and 4, a portion of the bottom wall 120 is covered on two opposite sides by the sidewall 111. For example, the attachment portion 117 may be a portion of the sidewall 111 that is folded over an end section 127 of the bottom wall 120 such that the end section 127 of the bottom wall 120 is sandwiched between a longitudinal end section 118 of the sidewall 111 and the attachment portion 117. The longitudinal end section 118 of the sidewall 111 may be on an opposite end (first end 101) to the opening 151 with respect to the chamber 150. The end section 127 of the bottom wall 120 may be a portion of the bottom wall 120 projecting therefrom. Naturally, it is also conceivable that a portion of the sidewall 111 may be covered on two opposite sides by the bottom wall 120. In FIGS. 6 to 10, an example for an alternative arrangement is shown. Therein, a portion of the sidewall 111 may be covered by a portion of the bottom wall 120 on one side. For example, the attachment portion 117 of the sidewall 111 may overlap with the end section 127 of the bottom wall 120. In FIG. 10, the bottom wall 120 is exemplarily illustrated with a sloped surface 122 and a flat surface 121. When joining the sidewall 111 and the bottom wall 120 of this example, overlap exists between the end section 127 of the sloped surface 122 and the longitudinal end section 118 of the sidewall 111. The sidewall 111 and the bottom wall 120 may be heat sealed or glued within the area of overlap. Naturally, it is also conceivable that a portion of the bottom wall 120 may be covered by the sidewall 111 on one side.

The bottom wall 120 may be arranged with respect to the sidewall 111 such that the bottom wall 120 is flush with the longitudinal end section 118 of the sidewall 111. This is exemplarily shown in FIGS. 6 to 9. However, other configurations are conceivable. For example, the bottom wall 120 may be connected to the sidewall 111 such that the longitudinal end section 118 (and the attachment portion 117) of the sidewall 111 projects from the bottom wall 120 in a direction opposite to the opening 151. This is exemplarily shown in FIGS. 2 to 5.

A further aspect of the present invention relates to a method for producing the capsule 100. The method comprises the step of providing a sheet made of the sheet material 200. Preferably, the primary sheet layer 210 may be provided (e.g. coated or laminated) with the individual layers of the secondary layers 220. The sheet material 200 is formed into the sidewall 111. Therein, the sheet material 200 may preferably be bent such that the secondary layers 220 form the outside of the capsule body 110 or face inside the chamber 150. Further, additionally or alternatively, the bottom wall 120 is formed from the sheet material 200 (e.g. a separate section of said sheet or a separate sheet). The bottom wall 120 is attached to the sidewall 111 so that the bottom wall 120 and the sidewall 111 form the capsule body 110 that encloses the chamber 150. The chamber is filled with a substance through the opening 151. The opening 151 is sealed with a membrane 400 to close the chamber 150. The membrane 400 may be a compostable (plastic) film. The sealing step is exemplarily shown in FIG. 11.

FIGS. 12 and 13 exemplarily illustrate advantages of the above method of producing the capsule 100 in view of the prior art. For example, in FIG. 13, the membrane 400 is able to adapt accurately to the contours of the rim 114 of the capsule 100. In comparison, in FIG. 12, a prior art beverage container 900 cannot be completely closed by the membrane 400. This is because beverage containers 900 may require that the material used for their bodies has a higher thickness to provide certain barrier properties. At the container rim 914, the higher material thickness causes that the membrane 400 cannot completely cover the overlapping end sections 914A, 914B of a container sidewall. Thus, a gap or hollow space forms between the membrane 400 and the end sections 914A, 914B that can be detrimental for the shelf life of the beverage container 900.

The invention is not limited by the embodiments as described hereinabove, as long as being covered by the appended claims. All the features of the embodiments described hereinabove can be combined in any possible way and be provided interchangeably.

For example, it is also conceivable that the primary sheet layer 210 may be provided on either side with the secondary layers 220 described above and thus, may be sandwiched between the secondary layers 220.

1. A capsule for preparing a beverage in a beverage preparation machine, wherein the capsule comprises a capsule body with a sidewall and a bottom wall defining a chamber for containing a substance for the preparation of the beverage, the chamber having an opening opposite to the bottom wall with respect to the chamber, wherein the sidewall and/or the bottom wall is made from a compostable multilayered sheet material having a moisture and oxygen barrier function, wherein the sheet material comprises
a primary sheet layer made of a formable cellulose-based material, and
one or more secondary layers comprising at least a moisture barrier layer to provide the moisture barrier function.

2. The capsule according to claim 1, wherein the primary sheet layer is made of a paper-based material and wherein preferably the primary sheet layer has a grammage between 100 g/m² to 400 g/m² and the primary sheet layer is configured such that it has an elongation at its breaking point of at least 2%.

3. The capsule according to claim 1, wherein the moisture barrier layer comprises a material selected from the group consisting of Polyvinylidene dichloride (PVDC), nanocellulose, microcellulose, Silicon nitride, Silicon oxide, Aluminium, and Aluminium oxide.

4. The capsule according to claim 1, wherein the primary sheet layer comprises the oxygen barrier function.

5. The capsule according to claim 1, wherein the secondary layers comprise an oxygen barrier layer for providing the oxygen barrier function, which is provided on an opposite side to the primary sheet layer with respect to the moisture barrier layer.

6. The capsule according to claim 1, wherein the secondary layers comprise at least one masking layer.

7. The capsule according to claim 1, wherein the primary sheet layer or the secondary layers comprise at least one base layer, which is configured to provide a reduced pore size, air permeability and surface roughness in comparison to another layer of the sheet material, on which the base layer is applied.

8. The capsule according to claim 7, wherein the base layer is provided
by the cellulose-based material of the primary sheet layer.

9. The capsule according to claim 1, wherein the outside surface and/or the chamber of the capsule body is defined by the primary sheet layer or the secondary layers.

10. The capsule according to claim 1, wherein the bottom wall is separate from the sidewall, and
wherein the capsule body comprises a rim portion at the opening that protrudes laterally away from the opening.

11. The capsule according to claim 1, wherein the sidewall comprises an attachment portion for attaching the bottom wall to the sidewall.

12. The capsule according to claim 1, wherein the bottom wall is flush with a longitudinal end section of the sidewall opposite to the opening with respect to the chamber.

13. The capsule according to claim 1, wherein the sidewall is formed by securing opposite end sections of the sheet material to each other by
overlapping the end sections and attaching a separate strip to one of the end sections and folding it over the front face of the one end section, or
abutting the end sections on their respective front faces and attaching a separate strip on each of the end sections on the same side with respect to the chamber so as to extend the strip over the abutting front faces.

14. A method for producing a capsule for preparing a beverage in a beverage preparation machine, the capsule comprising a capsule body with a sidewall and a bottom wall delimiting a chamber for containing a substance for the preparation of the beverage, the chamber having an opening opposite to the bottom wall with respect to the chamber, the method comprising:
providing a compostable multilayered sheet material having a moisture and oxygen barrier function, wherein the sheet material comprises
a primary sheet layer made of a formable cellulose-based material, and
one or more secondary layers comprising at least a moisture barrier layer to provide the moisture barrier function;
forming the sheet material to form the sidewall and/or the bottom wall of the capsule body;
attaching the bottom wall to the sidewall so that the bottom wall and the sidewall form the capsule body that encloses the chamber;
filling the chamber with a substance for the preparation of the beverage through the opening; and
sealing the opening with a membrane to close the chamber.

15. The method according to claim 14, wherein, in the step of forming the sheet material, the sheet material is bent such that the secondary layers form the outside of the capsule body or face inside the chamber.
